(19) United States
(12) Patent Application Publication
(10) Pub. No.: US 2026/0316690 A1
(43) Pub. Date: Oct. 15, 2026

(54) DISPLAY AND METHOD FOR REPRESENTING SIGNS AND/OR GRAPHICS, IN PARTICULAR ON VEHICLES

(71) Applicant: Ford Global Technologies, LLC, Dearborn, MI (US)

(72) Inventor: Daniele Trosa, Cologne (DE)

(73) Assignee: Ford Global Technologies, LLC, Dearborn, MI (US)

(21) Appl. No.: 19/466,652

(22) Filed: Feb. 2, 2026

(30) Foreign Application Priority Data
Mar. 26, 2025 (DE) 102025111625.3

(51) Int. Cl. B60R 11/02; G09F 9/33; G09F 21/04; B60R 11/00

(52) U.S. Cl. CPC B60R 11/0235; G09F 9/33; G09F 21/04; B60R 2011/004

(57) ABSTRACT

A display and a method for representing signs and/or graphics on a vehicle has at least one acrylic glass sheet and an LED lighting device arranged on the acrylic glass sheet. LEDs in the LED lighting device are arranged in a first matrix having a plurality of columns and a plurality of rows. The display is distinguished in that a frosted layer is arranged between the LED lighting device and the acrylic glass sheet and a colored pattern layer is arranged on an outer surface of the acrylic glass sheet facing away from the LED lighting device, the outer surface being at least partially covered by the colored pattern layer.

### CROSS-REFERENCE TO RELATED APPLICATION

This application claims foreign priority benefits under 35 U.S.C. § 119(a)-(d) to German Application No. 102025111625.3 filed Mar. 26, 2025, which is hereby incorporated by reference in its entirety.

### FIELD OF THE DISCLOSURE

The present disclosure generally relates to a display for representing signs and/or graphics on vehicles, and more specifically relates to a display with an acrylic glass sheet and an LED lighting arranged on the acrylic glass sheet.

### BACKGROUND OF THE DISCLOSURE

In automobile manufacture, emphasis is often placed on the external design appearance of vehicles in order to stand out from competitors. Manufacturers frequently offer personalization options by which customers can tailor the vehicle to their individual requirements and preferences. For example, colors or special coatings, trim levels, technology packages, wheel rim design, and the type of tires or accessories on the vehicle may be chosen by the customer. Decals, tint films for vehicle glass and the like, which may be used by customers for individual configuration of their vehicle

Various solutions for the configuration of vehicle glass are known, such as, for example, a windshield, side windows, a rear window or other glass surfaces on vehicles. The representation of signs and/or graphics on vehicles, in particular on vehicle components such as doors, a bumper, a tailgate, automobile glass or a radiator grill, is generally not widely supported.

It would be desirable to provide for enhanced displays and methods for representing signs and/or graphics, in particular on vehicles.

### SUMMARY OF THE DISCLOSURE

According to a first aspect of the present disclosure, a display for representing signs and/or graphics on a vehicle has at least one acrylic glass sheet and an LED lighting device arranged on the acrylic glass sheet. LEDs in the LED lighting device are arranged in a first matrix having a plurality of columns and a plurality of rows. A frosted layer is arranged between the LED lighting device and the acrylic glass sheet, and a colored pattern layer is arranged on an outer surface of the acrylic glass sheet facing away from the LED lighting device. The outer surface is at least partially covered by the colored pattern layer.

Embodiments of the first aspect of the present disclosure can include any one or a combination of the following features:
the display is integrated in a vehicle component;
the vehicle component comprises one of a door, a rear element, a bumper, a tailgate, automobile glass and a radiator grill;
the display is integrated in a vehicle component comprising a rear window;
the colored pattern layer has sections arranged in a second matrix;
the sections are configured with a circular, quadrilateral, triangular or oval shape;
the colored pattern is configured in a lattice;
the sections arranged in the second matrix coincide with positions of LEDs arranged in the first matrix, or in that the free regions arranged in the second matrix coincide with positions of LEDs arranged in the first matrix;
a control circuit; and
LEDs coupled to the control circuit which represent predetermined signs and/or graphics through controlled driving of selected LEDs.

According to a second aspect of the present disclosure, a vehicle has a vehicle component and a display for representing signs and/or graphics on a vehicle. The display has at least one acrylic glass sheet and an LED lighting device arranged on the acrylic glass sheet. LEDs in the LED lighting device are arranged in a first matrix having a plurality of columns and a plurality of rows. A frosted layer is arranged between the LED lighting device and the acrylic glass sheet, and a colored pattern layer is arranged on an outer surface of the acrylic glass sheet facing away from the LED lighting device. The outer surface is at least partially covered by the colored pattern layer.

Embodiments of the second aspect of the present disclosure can include any one or a combination of the following features:
the display is integrated in a vehicle component;
the vehicle component comprises one of a door, a rear element, a bumper, a tailgate, automobile glass and a radiator grill;
the display is integrated in a vehicle component comprising a rear window; and
the colored pattern layer has sections arranged in a second matrix.

According to a third aspect of the present disclosure, a method for representing signs and/or graphics on a vehicle provides a display having an acrylic glass sheet and an LED lighting device arranged on the acrylic glass sheet. LEDs in the LED lighting device are arranged in a first matrix having a plurality of columns and a plurality of rows. The LEDs in the first matrix represent signs and/or graphics by being driven by a control circuit. The display is integrated in a vehicle component, in that a frosted layer is provided between the LED lighting device and the acrylic glass sheet, and in that a pattern layer which at least partially covers the outer surface and has a color of the vehicle component is provided on an outer surface of the acrylic glass sheet facing away from the LED lighting device. The method further includes inactivating the LED lighting device such that the display appears to an observer in the color of the vehicle component as a result of the colored pattern layer, and activating the LED lighting device so that the light of the LEDs is emitted through uncovered free regions of the colored pattern layer when the LED lighting device is activated, so that the observer sees signs and/or graphics on the display.

Embodiments of the third aspect of the present disclosure can include any one or a combination of the following features:
the signs are letters, numerals, mathematical symbols, special characters or emojis;
the colored pattern layer has a plurality of sections arranged in the form of a second matrix;
the sections are configured with a circular, quadrilateral, triangular or oval shape;
the colored pattern is a lattice;
the colored pattern is configured in the form of a lattice;
the colored pattern layer is applied onto the outer surface of the acrylic glass sheet by a UV printing method; and
the method is performed on a vehicle component comprising one of a door, a rear element, a bumper, a tailgate, automobile glass and a radiator grill.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a rear perspective representation of a display for use on a vehicle, according to one embodiment;

FIG. 2 is a schematic view of one example of a first matrix of an LED lighting device on the display;

FIG. 3 is a side view of a portion of the display integrated on a vehicle component, according to one example;

FIG. 4 is a front view of the display as seen in FIG. 3, according to the disclosure;

FIG. 5a is an enlarged view of one example of the colored pattern layer;

FIG. 5b is an enlarged view of another example of the colored pattern layer;

FIG. 5c is an enlarged view of a further example of the colored pattern layer;

FIG. 6a is a front perspective view of a vehicle component having representations of signs and/or graphics on the display, which for example is arranged in a rear element;

FIG. 6b is a front perspective view of a vehicle component having representations of signs and/or graphics on the display, which for example is arranged in a rear element; and

FIG. 6c shows representations of signs and/or graphics on the display, which for example is arranged in a rear element.

### DETAILED DESCRIPTION OF PREFERRED EMBODIMENTS

In the various figures, parts which are the same are always provided with the same references, for which reason they are generally described only once.

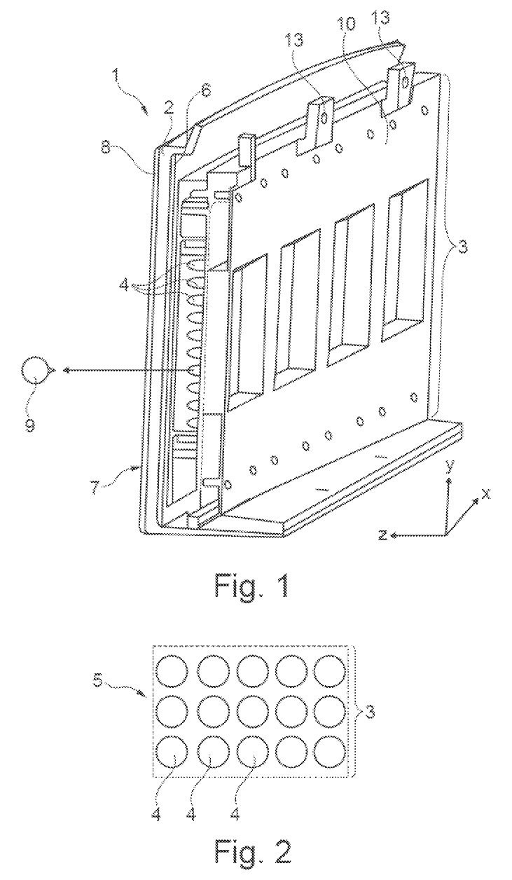

In FIG. 1, a display 1 having an acrylic glass sheet 2 is shown extending in the X and Y directions represented in the plane of the drawing. The X direction is also referred to as a width and the Y direction as a height.

The display 1 has a frosted layer 6 arranged between a light-emitting diode (LED) lighting device 3 and the acrylic glass sheet 2, and a colored pattern layer 8 is arranged on an outer surface 7 of the acrylic glass sheet 2 facing away from the LED lighting device 3. The colored pattern layer 8 is configured in such a way that it at least partially covers the outer surface 7 of the acrylic glass sheet 2. Such a translucent frosted layer 6 may be produced physically, for example by sandblasting the inner surface of the acrylic glass sheet 2, or chemically, for example by using chemicals which modify the surface properties of the inner surface of the acrylic glass sheet 2. The sandblasted surface may also be produced using an existing technology by sandblasting a clear material layer with electrodes. In this regard, the protective scope of the disclosure also includes a frosted element.

In such a display 1, a light beam generated by an LED 4 travels along a path through the frosted layer 6, the acrylic glass sheet 2 and the colored pattern layer 8 in a Z direction, which is also referred to as depth, before reaching an observer 9. This path in the Z direction is represented by way of example in FIG. 1 by use of an arrow which points toward the observer 9.

FIG. 2 shows a detail of an LED lighting device 3 having LEDs 4 arranged in a first matrix 5. The LEDs 4 in the first matrix 5 are arranged in a plurality of rows and a plurality of columns.

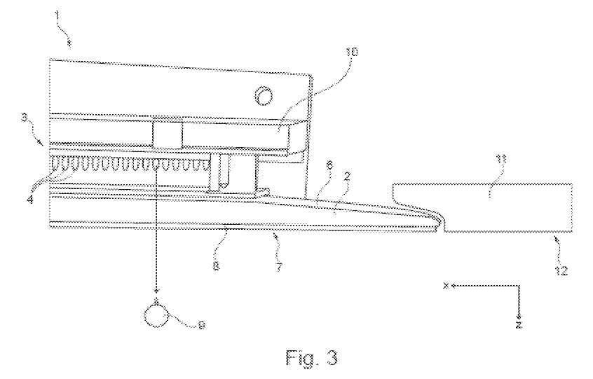

FIG. 3 shows a view of the display 1 according to the disclosure from above, only a part of the display 1 being represented. In FIG. 3, the display 1 again extends in the X and Y directions, the Y direction extending into FIG. 3 in an observation direction.

The LED lighting device 3 with its LEDs 4 represented by way of example is arranged in the frame 10. This frame 10 is also used in order to fasten the display 1 in a component that is embodied as a vehicle component 11, which is represented only partially. The vehicle component 11 is consistently referred to as a vehicle component 11 in what follows, although no restriction to the component being used on a vehicle is intended. The display 1 is arranged with its outer surface 7 flush with a further surface 12 of the vehicle component 11, in such a way that the surfaces 7 and 12 form a common plane.

The representation of FIG. 3 also represents the frosted layer 6 which is arranged between the LED lighting device 3 and the acrylic glass sheet 2. The colored pattern layer 8 arranged on the outer surface 7 of the acrylic glass sheet 2 can also be seen. FIG. 3 also represents by use of an arrow a light beam, generated by way of example by an LED 4, on its path to an observer 9 in the Z direction.

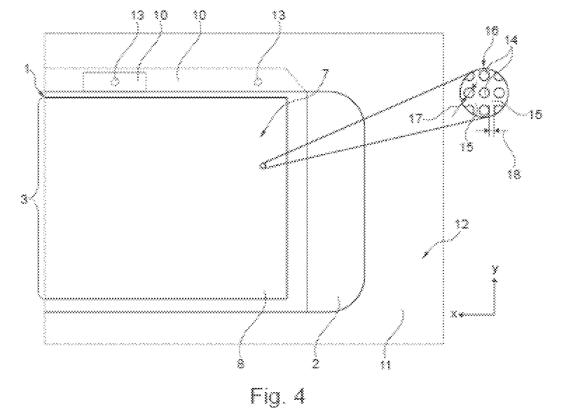

FIG. 4 shows a front view of the display 1 according to the disclosure and partially the colored pattern layer 8. In FIG. 4, the display 1 is represented as seen by an observer 9 looking at the display 1.

The display 1 is integrated in the vehicle component 11, for example a rear element, a bumper, a tailgate or a door. In the example of FIG. 4, a rectangular cutout is provided in the vehicle component 11, into which the acrylic glass sheet 2 is fitted. In this way, the display 1 is surrounded by the vehicle component 11. The outer surface 7 of the acrylic glass sheet 2 of the display 1 and the further surface 12 of the vehicle component 11 lie in a common plane.

For example, the frame 10, a plurality of fastening elements 13 which are used in order to fasten the display 1 in the vehicle component 11, and further contours of the display 1, are represented in the usual way as concealed physical edges by use of a dashed line. The display 1 has a region where the signs and/or graphics can be represented, which corresponds to the size of the first matrix 5, while the acrylic glass sheet 2 extends beyond this region.

In order to represent the structure of the colored pattern layer 8 in more detail with reference to an example, FIG. 4 shows a circular region partially in an enlarged representation. Sections 14 of the colored pattern layer 8 can therefore be seen, which are configured merely by way example with a circular shape. The sections 14 are arranged by way of example in a plurality of columns and a plurality of rows, and in this way form a second matrix 16. Free regions 15 created between the sections 14 in the colored pattern layer 8 can also be seen. While the sections 14 cover the outer surface 7 of the acrylic glass sheet 2 in color, the outer surface 7 remains uncovered, or free, in the free regions 15. The colored sections 14 of the colored pattern layer 8 which are arranged in the second matrix 16 create the impression for an observer that the outer surface 7 is configured with a continuous colored coat.

For this purpose, the sections 14 have a diameter 17 which in one example preferably lies in a range of between 0.5 mm and 3.0 mm, and in particular is 1.5 mm, for example. The colored sections 14 arranged in the second matrix 16 have a gap 18 from one another, for example in a row and/or in a column, which lies between 0.5 mm and 2.0 mm, according to one example.

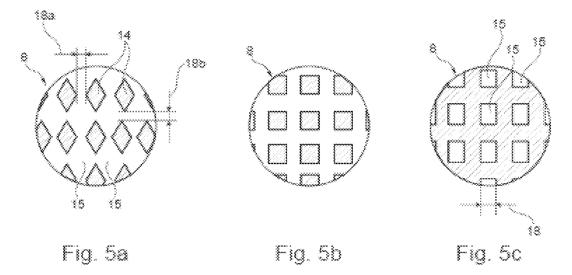

FIGS. 5a, 5b and 5c show by way of example various embodiments of the colored pattern layer 8. In the example of FIG. 5a, the sections 14 are configured with four sides in a rhombic shape. The free regions 15 are formed next to the sections 14. In the embodiment of FIG. 5a, the diameter 17 is for example an average value of the two diagonals d1 and d2 of the rhombus of the section 14. The gaps 18a and 18b are indicated in a row with a first value for the gap 18a and in a column with a second value 18b, which is different to the first value, for the gap 18b.

In the example of FIG. 5a, the sections 14 are likewise configured with a quadrilateral shape, in particular a square shape. The diameter is to be understood as a side length of the square. The gaps 18 are configured identically in the rows and columns.

In FIGS. 5a and 5b, the free regions 15 between the sections 14 are configured continuously. FIG. 5c shows a colored pattern layer 8 configured in the form of a lattice. The free regions 15 are formed between the strips, which are configured for example with an equal width and which run horizontally and vertically in the colored pattern layer 8. In this embodiment, the free regions 15 are separated from one another by the strips.

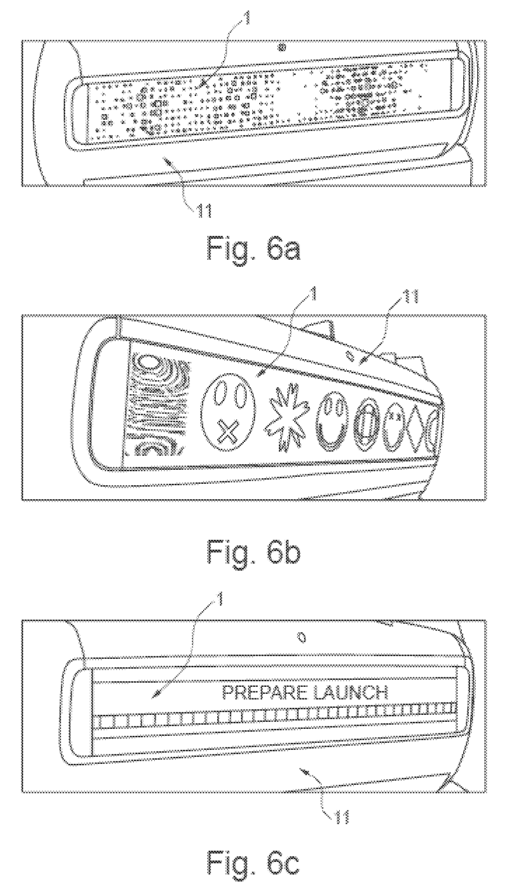

FIGS. 6a, 6b and 6c show representations of signs and/or graphics on a display 1 arranged in a vehicle component 11, for example a rear element, a bumper or a tailgate. In FIG. 6a, various graphics or patterns are indicated on the display 1, for example with the graphic in the left subregion of the display 1 being represented in a primarily light, that is to say for example yellow, hue, the graphic in the central subregion of the display 1 in a primarily dark, that is say for example red, hue, and the graphic in the right subregion of the display 1 in a color mixture of light and dark hues. This is naturally to be understood merely by way of example. It is also within the scope of the disclosure to display other representations, as is shown by way of example in FIGS. 6b and 6c.

Besides various graphics, FIG. 6b also represents so-called emojis, that is to say a small digital image or symbol, on the display 1. Both the graphics and the emojis may vary in their appearance over time or be represented at different positions of the display, for example in order to create the impression of movement, although this is not represented in Fig, 6b.

In FIG. 6c, a phrase is essentially represented on the display 1. In such representations, it is also possible so to speak to move the phrase in the representation region of the display 1. Alternatively, the phrase or a longer text may be represented by scrolling on the display 1, although this is not represented in FIG. 6c.

The present disclosure provides a display and a method for representing signs and/or graphics, in particular on vehicles, with which integration into a component, in particular a vehicle component, and color matching to a color of the component, in particular the vehicle component, are achieved while ensuring faithful color representation of signs and/or graphics.

In the present description, signs mean any type of symbols; these are also used for communication. Such signs are for example letters, numerals, mathematical symbols, so-called special characters and emojis, etc. The term graphics includes visual representations such as for example photographs, diagrams, illustrations and other pictorial representations.

A display is proposed for representing signs and/or graphics, in particular on vehicles, wherein the display comprises at least one acrylic glass sheet and an LED lighting device arranged on the acrylic glass sheet, and wherein LEDs in the LED lighting device are arranged in a first matrix having a plurality of columns and a plurality of rows. According to the disclosure, a frosted layer is arranged between the LED lighting device and the acrylic glass sheet and a colored pattern layer is arranged on an outer surface of the acrylic glass sheet facing away from the LED lighting device, the outer surface being at least partially covered by the colored pattern layer.

A method is proposed for representing signs and/or graphics, in particular on vehicles, in which a display having an acrylic glass sheet and an LED lighting device arranged on the acrylic glass sheet is provided, wherein LEDs in the LED lighting device are arranged in a first matrix having a plurality of columns and a plurality of rows, and wherein the LEDs in the first matrix represent signs and/or graphics by being driven by a control circuit. According to the disclosure, the display is integrated in a component, in particular a vehicle component, a frosted layer being provided between the LED lighting device and the acrylic glass sheet, a colored pattern layer which at least partially covers the outer surface and has a color of the component, in particular the vehicle component, being provided on an outer surface of the acrylic glass sheet facing away from the LED lighting device, the display appearing to an observer in the color of the component, in particular the vehicle component, when the LED lighting device is inactive because of the pattern layer, and light of the LEDs preferably being emitted through uncovered free regions of the colored pattern layer when the LED lighting device is driven. The observer can thus see signs and/or graphics on the display.

It should be pointed out that the features and measures mentioned individually in the following description may be combined with one another in any desired technically expedient way and represent further configurations of the disclosure. The description additionally characterizes and specifies the disclosure particularly in conjunction with the figures.

A display is proposed for representing signs and/or graphics on vehicles, which is integrated into a component, in particular a vehicle component, such as a bodywork component. Such vehicle components may for example be understood to include a rear element, in particular above bumpers, doors, bumpers, a tailgate, automobile glass, in particular a rear window, or a radiator grill. The disclosure may also be employed for headlamps, tail lamps, interior components, panoramic roofs, sunroofs, and other applications outside the automotive industry, for example advertising and special furniture for businesses, events or exhibitions.

A display in the context of the disclosure has at least one acrylic glass sheet, on the inner surface of which an LED lighting device comprising a multiplicity of LEDs is arranged. The LEDs in the LED lighting device are usually arranged in a plurality of columns and a plurality of rows so as to form a first matrix.

Acrylic glass is a transparent thermoplastic, which is normally produced from polymethyl methacrylate (PMMA). Acrylic glass represents an alternative to glass, and is often used particularly in automobile manufacture since acrylic glass has a lower weight and a higher breaking strength. For displays, acrylic glass is used in the form of acrylic glass sheets.

According to the disclosure, a translucent frosted layer is arranged on the inner surface, that is to say between the acrylic glass sheet and the LED lighting device. Such a translucent frosted layer may be produced physically, for example by sandblasting the inner surface of the acrylic glass sheet, or chemically, for example by using chemicals which modify the surface properties of the inner surface of the acrylic glass sheet. The sandblasted surface may also be produced using an existing technology by sandblasting a clear material layer with electrodes. In this regard, the protective scope of the disclosure also includes a frosted element. A further possibility for producing the translucent frosted layer includes applying a special matt coating or a film onto the inner surface of the acrylic glass sheet. The advantage of the translucent frosted layer is that the color effect of the colored pattern layer described below is enhanced, or optically reinforced, by scattering the light. This means that when complying with a minimum distance, for example at least 80 cm, an observer perceives the display in the color of the pattern layer even though the pattern layer only partially covers the outer surface of the acrylic glass sheet.

Furthermore, according to the disclosure, a colored pattern layer is arranged on an outer surface of the acrylic glass sheet facing away from the LED lighting device. This colored pattern layer at least partially covers the outer surface, which means that the colored pattern layer does not fully overlay the outer surface but, for example, has regular openings which may be arranged in columns and rows. In this way, it is possible for the light emitted by the LEDs of the LED lighting device to emerge from the display through the openings and be visible to the observer of the display without modifying the hue generated by the LEDs.

In one embodiment, the display is integrated in a component, in particular a vehicle component, in which case a vehicle component may be a door, a bumper, a tailgate, automobile glass, a taillight, as well as a rear window or a radiator grill.

In the context of the disclosure, integrated into a component, in particular a vehicle component, means that the outer surface of the acrylic glass sheet of the display is flush with a surface of a component, in particular a vehicle component. There is a smooth transition between the surfaces. In this arrangement, the surfaces lie substantially in a common plane. When a surface of a component, in particular a vehicle component, has a curved profile, the outer surface of the acrylic glass sheet of the display is correspondingly also configured with this curved profile. In any event, a common surface is in this way formed for an observer of the component, in particular the vehicle component, with the integrated display.

According to a further embodiment, the colored pattern layer has sections arranged in the form of a second matrix, which are configured with a circular, quadrilateral, triangular or oval shape, or the colored pattern layer is configured in the form of a lattice.

The colored pattern layer, which only partially covers the outer surface of the acrylic glass sheet of the display, has sections which, for example, are configured with a circular, quadrilateral, in particular rectangular, triangular or oval shape or as any desired polygon. A diameter of the sections lies in a range of between 0.5 mm and 3.0 mm, in particular 1.5 mm. In regions where no sections are arranged in the colored pattern layer, so-called free regions are formed. In these free regions, the outer surface of the acrylic glass sheet is exposed, i.e. not covered by sections of the colored pattern layer.

The sections are preferentially arranged in a plurality of columns and a plurality of rows, and in this way form a second matrix. The sections are configured in a desired color. The colored sections arranged in the second matrix are, for example, arranged in a row and/or in a column in such a way that a gap between two neighboring colored sections on the outer surface lies in a range of between 0.5 mm and 2.0 mm, for example. For an observer who complies with a minimum distance of at least 80 cm from the outer surface of the display, this creates an impression of a continuous area on the display, which is configured in the color of the component, in particular the vehicle component. The free regions between the colored sections can of course be seen from a shorter distance of the observer. In what follows, in connection with an observer it will always be assumed that the observer complies with the aforementioned minimum distance, without this being explicitly mentioned on every occasion.

In an alternative embodiment, the colored pattern layer is configured in the form of a lattice of intersecting strips. The strips of the colored pattern layer in the form of a lattice, which are colored preferentially in the color of the corresponding component, in particular the vehicle component, are for example arranged at an angle of 90 degrees to one another. The strips of the colored pattern layer in the form of a lattice may for example run horizontally and vertically. Between the strips, there are, e.g., quadrilateral free regions in which the outer surface of the acrylic glass sheet of the display is not covered.

It is expedient that a color of the colored pattern layer corresponds to an external coating of the component, in particular the vehicle component, on which the display is arranged.

The outer surface of the acrylic glass sheet of the display therefore appears to an observer in the same color in which the vehicle component is configured. When a component, in particular a vehicle component, is configured in multiple colors, for example with colored strips or a color profile, the colored pattern layer may also be configured in such a way that it corresponds to the colored strips or the color profile, so that a uniform continuous colored area is formed for the observer even though the colored pattern layer still has the free regions described above.

According to one embodiment of the disclosure, the sections arranged in the second matrix coincide with positions of LEDs arranged in the first matrix, or the free regions arranged in the second matrix coincide with positions of LEDs arranged in the first matrix.

As mentioned above, the LEDs in the LED lighting device are arranged in a plurality of columns and a plurality of rows so as to form a first matrix, while the colored sections are preferentially arranged in a plurality of columns and a plurality of rows so as to form a second matrix.

Preferentially, the first matrix may be aligned with respect to the second matrix in such a way that the LEDs of first matrix are positioned at the locations of the sections of the pattern layer of the second matrix.

Alternatively, the LEDs of the first matrix may be positioned in free regions of the second matrix. An advantage of this positioning is that the light emitted by the LEDs of the LED lighting device can emerge from the display unimpeded and with color fidelity through the free regions.

In one embodiment, the LEDs are connected to a control circuit which represents predetermined signs and/or graphics through controlled driving of selected LEDs.

In the usual way, the LEDs of the LED lighting device are connected to a control circuit which drives the LEDs. This control circuit, which for example is connected to a microprocessor, generates control signals for the LEDs, with which for example a required brightness and/or required color of one or more LEDs can be generated. In conjunction with the usual driving of a plurality of LEDs in the first matrix, signs and/or graphics are generated in this way. In this context, it is also known to represent signs such as a word or a text in the display statically, at a fixed position in the display, or dynamically in the form of scrolling, in which the text is moved for example horizontally over the display.

In order to carry out the method for representing signs and/or graphics, a display having an acrylic glass sheet and an LED lighting device arranged on the acrylic glass sheet is provided, wherein LEDs in the LED lighting device are arranged in a first matrix having a plurality of columns and a plurality of rows. The LEDs in the first matrix are driven by a control circuit in order to represent signs and/or graphics.

The display according to the disclosure is integrated in a component, in particular a vehicle component, a frosted layer being provided between the LED lighting device and the acrylic glass sheet, and a colored pattern layer which at least partially covers the outer surface and preferentially has a color of the component, in particular the vehicle component, being provided on an outer surface of the acrylic glass sheet facing away from the LED lighting device. The colored pattern layer has colored sections which cover the outer surface. The colored pattern layer also has free regions in which the outer surface is not covered.

According to the disclosure, because of the colored sections of the colored pattern layer, the display appears to an observer as a continuous colored surface despite the free regions in the colored pattern layer, for example when the observer is not closer than the minimum distance of at least 80 cm from the display. In this way, in an inactive state of the LED lighting device, the observer scarcely perceives the display integrated in the component, in particular the vehicle component such as a bumper, a tailgate or a door, that is to say they do not discern a difference from the surrounding component, in particular the vehicle component. They see a homogeneous uninterrupted area. An inactive state of the LED lighting device is in this case a state in which the LEDs of the LED lighting device do not emit light, that is to say for example they are not driven by the control circuit.

In order to represent signs and/or graphics on the display, the LEDs of the LED lighting device are driven suitably by the control circuit; the driven LEDs emit light. The LEDs may emit light with different brightnesses and different colors in order to represent desired signs and/or graphics on the display.

In this state of driving the LEDs of the LED lighting device, the light emitted by the LEDs emerges from the display through the free regions of the colored pattern layer and in this way can reach the observer. In this state of driving the LED lighting device, the observer no longer perceives the colored sections of the colored pattern layer because of the brightness of the LEDs, and they can see the represented signs and/or graphics on the display with color fidelity.

In one embodiment of the method, the signs represented by the display are letters, numerals, mathematical symbols, special characters or emojis. In this way, a variety of information can be represented on the display. Besides words, whole sentences may for example also be represented on the display in the form of scrolling.

In one example, information for other road users may be represented by a display integrated in a door or a tailgate, or in a bumper. Such information may for example be promotional information. Such information may also notify of extreme events, for example when it has been observed that the vehicle is approaching the end of a traffic jam. Likewise, a notification message may be represented on the display if a fault has been identified in the vehicle or when the physical condition of the driver gives cause for concern.

In one embodiment, the colored pattern layer has a plurality of sections arranged in the form of a second matrix, the sections being configured with a circular, quadrilateral, triangular or oval shape.

By configuring the colored pattern layer with sections and free regions having the coordinated dimensions mentioned above, the observer perceives the display in the inactive state of the LED lighting device as a uniform colored area and in the active state of the LED lighting device as a normal display representing signs and/or graphics on the vehicle. These properties are alternatively also achieved by the colored pattern layer having strips in the form of a lattice. In one embodiment, the colored pattern layer is applied onto the outer surface of the acrylic glass sheet by use of a UV printing method.

In particular, a UV printing method in which ultraviolet light (UV light) is used in order to cure the colored pattern layer which has been applied onto the outer surface of the acrylic glass sheet by use of a printhead can be employed or is employed. The method uses special UV-curing inks which, as is usual in color printheads, can generate a desired hue of the colored pattern layer from the primary colors stored in the printhead. The colored pattern layer may therefore be applied easily and rapidly with variously shaped geometrical sections and free regions. Moreover, the colored pattern layer may preferably be matched optimally to the hue of the component, in particular the vehicle component.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A display for representing signs and/or graphics on a vehicle, wherein the display comprises:
at least one acrylic glass sheet;
an LED lighting device arranged on the acrylic glass sheet, wherein LEDs in the LED lighting device are arranged in a first matrix having a plurality of columns and a plurality of rows;
a frosted layer arranged between the LED lighting device and the acrylic glass sheet; and a colored pattern layer arranged on an outer surface of the acrylic glass sheet facing away from the LED lighting device, wherein the outer surface is at least partially covered by the colored pattern layer.

2. The display according to claim 1, wherein the display is integrated in a vehicle component, the vehicle component comprising one of:
a door;
a rear element;
a bumper;
a tailgate;
automobile glass; and
a radiator grill.

3. The display according to claim 1, wherein the display is integrated in a vehicle component comprising a rear window.

4. The display according to claim 1, wherein the colored pattern layer has sections arranged in a second matrix.

5. The display according to claim 4, wherein the sections are configured with a circular, quadrilateral, triangular or oval shape.

6. The display according to claim 4, wherein the colored pattern is configured in a lattice.

7. The display according to claim 4, wherein the sections arranged in the second matrix coincide with positions of LEDs arranged in the first matrix, or in that the free regions arranged in the second matrix coincide with positions of LEDs arranged in the first matrix.

8. The display according to claim 1, further comprising a control circuit, wherein the LEDs are coupled to the control circuit which represent predetermined signs and/or graphics through controlled driving of selected LEDs.

9. A vehicle comprising:
a vehicle component; and
a display for representing signs and/or graphics on a vehicle, wherein the display comprises:
at least one acrylic glass sheet;
an LED lighting device arranged on the acrylic glass sheet, wherein LEDs in the LED lighting device are arranged in a first matrix having a plurality of columns and a plurality of rows;
a frosted layer arranged between the LED lighting device and the acrylic glass sheet; and
a colored pattern layer arranged on an outer surface of the acrylic glass sheet facing away from the LED lighting device, wherein the outer surface is at least partially covered by the colored pattern layer.

10. The vehicle of claim 9, wherein the display is integrated in a vehicle component, the vehicle component comprising one of:
a door;
a rear element;
a bumper;
a tailgate;
automobile glass; and
a radiator grill.

11. The display according to claim 9, wherein the display is integrated in a vehicle component comprising a rear window.

12. The display according to claim 9, wherein the colored pattern layer has sections arranged in a second matrix.

13. A method for representing signs and/or graphics on a vehicle, the method comprising:
providing a display having an acrylic glass sheet and an LED lighting device arranged on the acrylic glass sheet, wherein LEDs in the LED lighting device are arranged in a first matrix having a plurality of columns and a plurality of rows, and wherein the LEDs in the first matrix represent signs and/or graphics by being driven by a control circuit, wherein the display is integrated in a vehicle component, in that a frosted layer is provided between the LED lighting device and the acrylic glass sheet, and in that a pattern layer which at least partially covers the outer surface and has a color of the vehicle component is provided on an outer surface of the acrylic glass sheet facing away from the LED lighting device;
inactivating the LED lighting device such that the display appears to an observer in the color of the vehicle component as a result of the colored pattern layer; and
activating the LED lighting device so that the light of the LEDs is emitted through uncovered free regions of the colored pattern layer when the LED lighting device is activated, so that the observer sees signs and/or graphics on the display.

14. The method according to claim 13, wherein the signs are letters, numerals, mathematical symbols, special characters or emojis.

15. The method according to claim 13, wherein the colored pattern layer has a plurality of sections arranged in the form of a second matrix.

16. The method according to claim 15, wherein the sections are configured with a circular, quadrilateral, triangular or oval shape.

17. The method according to claim 15, wherein the colored pattern is a lattice.

18. The method according to claim 15, wherein the colored pattern is configured in the form of a lattice.

19. The method according to claim 13, wherein the colored pattern layer is applied onto the outer surface of the acrylic glass sheet by a UV printing method.

20. The method according to claim 13, wherein the method is performed on a vehicle component comprising one of:
a door;
a rear element;
a bumper;
a tailgate;
automobile glass; and
a radiator grill.
